(19) United States
(12) Patent Application Publication
(10) Pub. No.: US 2008/0005709 A1
(43) Pub. Date: Jan. 3, 2008

(54) VERIFICATION OF LOGIC CIRCUITS USING CYCLE BASED DELAY MODELS

(75) Inventor: AMIT GOLANDER, Tel-Aviv (IL)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/427,854

(22) Filed: Jun. 30, 2006

(51) Int. Cl. G06F 17/50

(52) U.S. Cl. 716/6; 703/16

(57) ABSTRACT

Methods and systems for verifying a logic circuit. In one embodiment, delay models based on clock cycles are developed and incorporated into the logic circuit so that timing considerations may be simulated.

### FIELD OF THE INVENTION

The invention relates to logic circuit verification.

### BACKGROUND OF THE INVENTION

Modern logic circuits may have up to hundreds of clock domains. Inevitably, there are paths which cross from one clock domain to another where the clock frequencies and possibly the phases in the clock domains differ. There are many common approaches for dealing with paths which cross clock domains (here and below clock domain crossing paths) when designing and verifying a logic circuit. In a first approach the use of clock domain crossing paths is forbidden in the design. This approach is not very realistic as it limits the design space. In a second approach, the logic circuit is designed or redesigned to operate at the higher clock frequency within each clock domain crossing path. This approach is often not possible, and even when possible this approach puts unnecessary restrictions on the design. Due to the need for faster logic this approach also represents a costly implementation with regard to size and power consumption. A third approach verifies the logic circuit using SDF (Standard Delay Format) driven simulation, which loads the exact timing model for each gate and optionally wires. This simulation is typically slower by more than an order of magnitude than an SDF-free simulation and it is difficult for the simulation to achieve reasonable coverage on large hardware designs. In a fourth approach, the clock domain crossing paths are reviewed manually during verification of the logic circuit. This, too, is problematic as there may be hundreds and thousands of paths, and the designers, who may in any case be legacy or third-party subcontractors, may not always be available to undertake the manual review and, even if they are, the sheer scope of the work is prone to error. Following the manual review, the fourth approach includes further verifying of the circuit using a simulation which is SDF-free, where the assumption is that there are no timing delays for gates and wires. This simulation may be problematic in that cross domain crossing paths may not be properly verified.

### SUMMARY OF THE INVENTION

According to the present invention, there is provided: a method of verifying a path in a logic circuit, comprising: determining that a validity of an output logic level of a memory element on a path is uncertain for M clock cycles of a clock driving the memory element; creating a delay model configured to model at least one of M possible integer multiples of clock cycles for the clock, the possible integer multiples ranging from 0 to M−1; and instantiating the delay model in the path so that if the path is simulated, a path delay equaling an integer multiple of clock cycles for the clock is simulated for the path.

According to the present invention, there is also provided: a method of verifying a path in a logic circuit, comprising: determining that a validity of an output logic level of a memory element on a path is uncertain for M clock cycles of a clock driving the memory element, wherein any other clocks on the path are synchronized with that clock; creating a delay model configured to model at least one of M possible integer multiples of clock cycles for that clock, the possible integer multiples ranging from 0 to M−1; instantiating the delay model in the path; and simulating the path, wherein a path delay equaling an integer multiple of clock cycles for that clock is simulated for the path.

According to the present invention, there is further provided: a system for verifying a path in a logic circuit comprising: means for determining that a validity of an output logic level of a memory element on a path is uncertain for M clock cycles of a clock driving the memory element; means for creating a delay model configured to model at least one of M possible integer multiples of clock cycles for the clock, the possible integer multiples ranging from 0 to M−1; and means for instantiating the delay model in the path so that if the path is simulated, a path delay equaling an integer multiple of clock cycles for the clock is simulated for the path.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a logic circuit, according to an embodiment of the present invention;

FIG. 2 illustrates timing diagrams, according to an embodiment of the present invention;

FIG. 3 is another logic circuit, according to an embodiment of the present invention;

FIG. 4 is another logic circuit, according to an embodiment of the present invention;

FIG. 5 is another logic circuit, according to an embodiment of the present invention;

FIG. 6 is a flowchart of a method for verifying logic circuits, according to an embodiment of the present invention;

FIG. 7 is a system for verifying logic circuits, according to an embodiment of the present invention;

FIG. 8 is the logic circuit of FIG. 1 with a delay model incorporated, according to an embodiment of the present invention;

FIG. 9 is the logic circuit of FIG. 3 with delay models incorporated, according to an embodiment of the present invention;

FIG. 10 is the logic circuit of FIG. 4 with delay models incorporated, according to an embodiment of the present invention; and

FIG. 11 is the logic circuit of FIG. 5 with delay models incorporated, according to an embodiment of the present invention.

### DETAILED DESCRIPTION OF EXEMPLARY EMBODIMENTS

Described herein are embodiments of the current invention for logic circuit verification.

As used herein, the phrase “for example,” “such as” and variants thereof describing exemplary implementations of the present invention are exemplary in nature and not limiting.

As used herein, the term “designer” refers to one or more individuals and/or machines involved in the preparation of a logic circuit in any one or more phases of the preparation, including inter-alia conception, design, building, and verification phases.

In the description below it is assumed for ease of explanation that changes in memory elements are triggered by rising clock edges but in other embodiments other clock triggers may be used, mutatis mutandis.

Modern logic circuits typically have a relatively small number of phase locked loops PLLs. Therefore it is common to see a single clock source after passing frequency dividers functioning as a plurality of clocks with differing frequencies which have a regular and/or predictable phase relationship. A good example is IBM's CoreConnect where the main clocks PPC (PowerPC), PLB (Processor Local Bus), OPB (On-chip Peripheral Bus) and EXT (External) can be for example 500, 166, 83 and 83/N, all with integer ratio (1:3:6:6N) from one another and derived from the same phase locked loop.

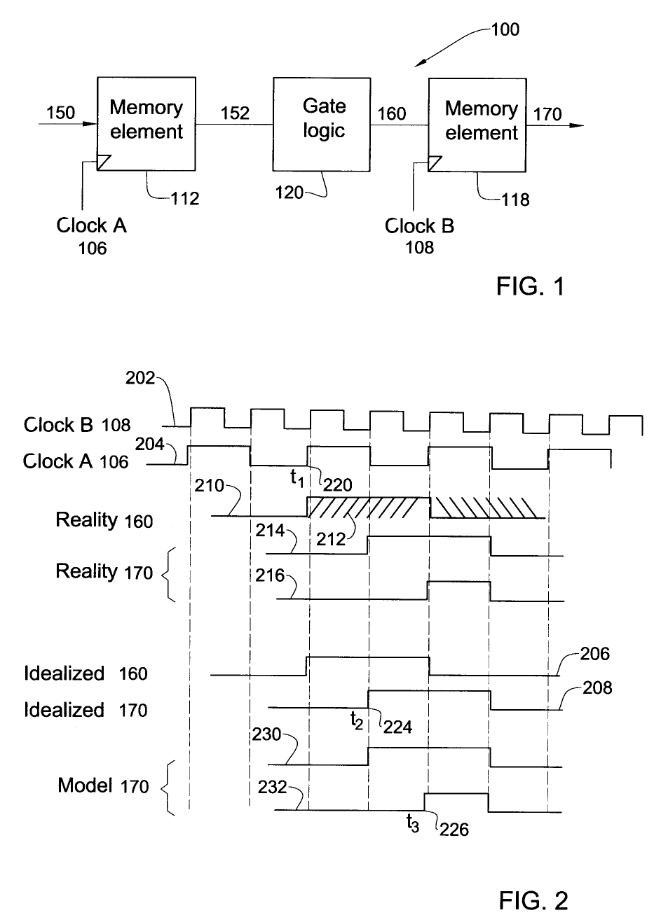

Refer to FIG. 1 which illustrates a simplified logic circuit 100 having an input 150, according to an embodiment of the present invention. Clock A 106 drives a memory element 112. The output 152 of memory element 112 is fed into gate logic 120 (along with possibly other inputs) and the output 160 of gate logic 120 is fed into memory element 118. Clock B 108 drives memory element 118 to produce an output 170. Clocks A 106 and B 108 are assumed to be synchronous clocks. Here and below “synchronous clocks” (or clocks which are synchronized, or similar terms) refer to clocks which have a regular and/or predictable phase relationship.

In an idealized world, gate logic 120 (and wiring) would contribute an infinitesimally small (practically zero) delay and output 170 would reflect any change in output 152 on the next triggering clock edge of clock B 108 However due to the delay in gate logic 120 and output 160, output 170 may in some cases instead reflect the change at a later time. For example, output 170 may reflect the change at a later triggering clock edge of clock B 108.

Refer to FIG. 2 which shows timing diagrams for clock A 106 and clock B 108, according to an embodiment of the present invention. In FIG. 2 it is assumed that clock B 108 is twice as fast (i.e. double the frequency of clock A 106). Therefore every second rising edge of clock B 108 rises at the same time as the rising edge of clock A 106. Clock B 108 is illustrated by timing diagram 202 and clock A 106 is illustrated by timing diagram 204. Further assume that output 152 of memory element 112 goes high at time point t₁ 220 corresponding to a certain triggering clock edge of clock A 106. In an idealized world, where there are infinitesimal time delays for logic gates and/or wires, there would be practically no delay and the input 160 to memory element 118 would also go high at time point t₁ 220 as illustrated in timing diagram 206. Ideally, output 170 would go high on the next clock cycle t₂ 224 (see timing diagram 208) However in reality, there is a real metastability period 212, which means the logic state of input 160 is unclear (see timing diagram 210). Therefore in reality, output 170 can go high on the next rising edge at t₂ 224 (timing diagram 214) or after a delay of one rising edge at t₃ 226 (timing diagram 216). (Note that for simplicity of illustration other possibilities of when de-assertion occurs for output 170 are not shown in FIG. 2)

One embodiment of the invention includes the realization that often, as in FIG. 1, a path in a logic circuit passes between a source memory element (in FIG. 1 element 112) and a destination memory (in FIG. 1. element 118) driven by synchronous clocks. This embodiment therefore provides a method and system for inserting a delay when simulating such logic circuits where the delay is a function of the clock cycle of the clock which drives the destination memory element. Timing diagrams 230 and 232 of FIG. 2 illustrate the delay modeling, assuming that the maximum delay equals 1 cycle of clock B 108. Because output 170 asserts only upon the rising edge of clock B 108, the path delay is modeled as equaling 0 cycles of clock B 108 (i.e. no delay) as shown in timing diagram 230 where output 170 rises at t₂ 224, or the path delay is modeled as equaling one cycle of clock B 108 as shown in timing diagram 232 where output 170 rises at t₃ 226. In this embodiment, the number of delay cases for assertion which are modeled equals the ratio of the frequency of clock B 108 to the frequency of clock A 106. In other embodiments, the number of delay cases may be different than the ratio of frequencies, as will be explained in more detail further below. (Note that for simplicity of illustration other possibilities of when de-assertion can be modeled for output 170 are not shown in FIG. 2)

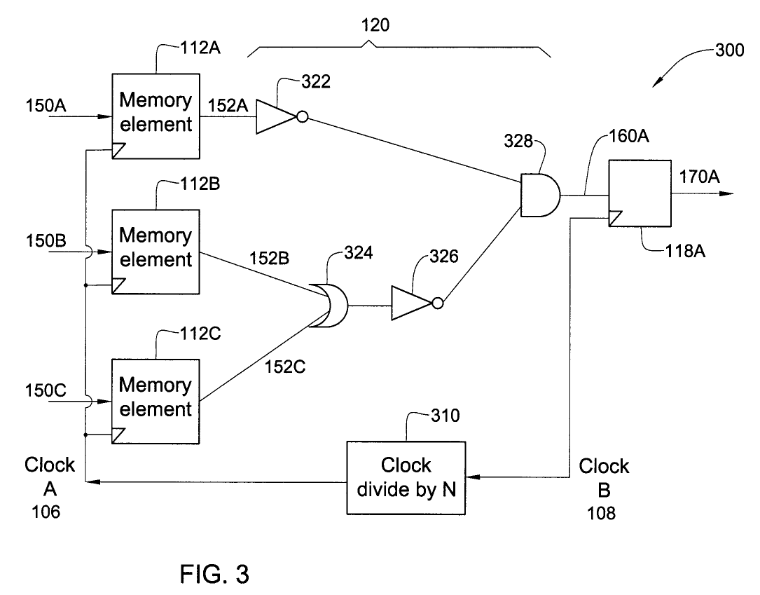

FIG. 3 through 5 illustrate three simplified logic circuits, which represent different embodiments of logic circuit 100 having inputs 150A, 150B, 150C, with one or more paths leading from memory element(s) driven by clock A 106 to a memory element driven by clock B 108. Letters are added to item numbers to clarify that although an element may be different, for the purposes of discussion the functionality is similar as in circuit 100. The logic circuits illustrated in FIG. 3 through 5 are simplified to ease understanding for the reader of how an embodiment of the invention verifies logic circuits and should not be construed as typical of logic circuitry or as exhaustive.

In FIG. 3 clock A 106 which drives three memory elements (for e.g. flip flops) 112A, 112B, and 112C, and clock B 108 drives memory element 118A. In this example, clock B 108 operates at a higher frequency than clock A 106 (where N is the ratio of the frequencies of clock B 108 to clock A 106) and clock B 108 and clock A 106 are synchronous, i.e. that the phases of clock B 108 and clock A 106 have a predictable relationship. Clock B 108 and clock A are synchronized because clock A 106 derives from clock B 108 after passing through a clock divider 310 which divides the frequency by N. The logic 120 illustrated in FIG. 3 includes a NOT gate 322 on the output path of memory element 112A, an OR gate 324 “or'ing” together the outputs of memory elements 112B and 112C, a NOT gate 326, on the output path from OR gate 324, and an AND gate 328 “and'ing” together the outputs of NOT gate 322 and NOT gate 326. The output of AND gate 328 is fed into memory element 118 as input 160A. In this example, the path from memory element 112A through memory element 118A, the path from memory element 112B through memory element 118, and the path from memory element 112C through memory element 118A may each have the same amount or differing amounts of propagation delay due to logic 120 (and/or wires). However, due to the synchronization between clock A 106 and clock B 108, any changes in output 152 would be reflected in output 170A (i.e. output 170A would reach a valid logic state) on a triggering clock edge of clock B 108, either the next clock edge after the clock edge of clock A which caused the change in output 152A, B and/or C or at a subsequent clock edge.

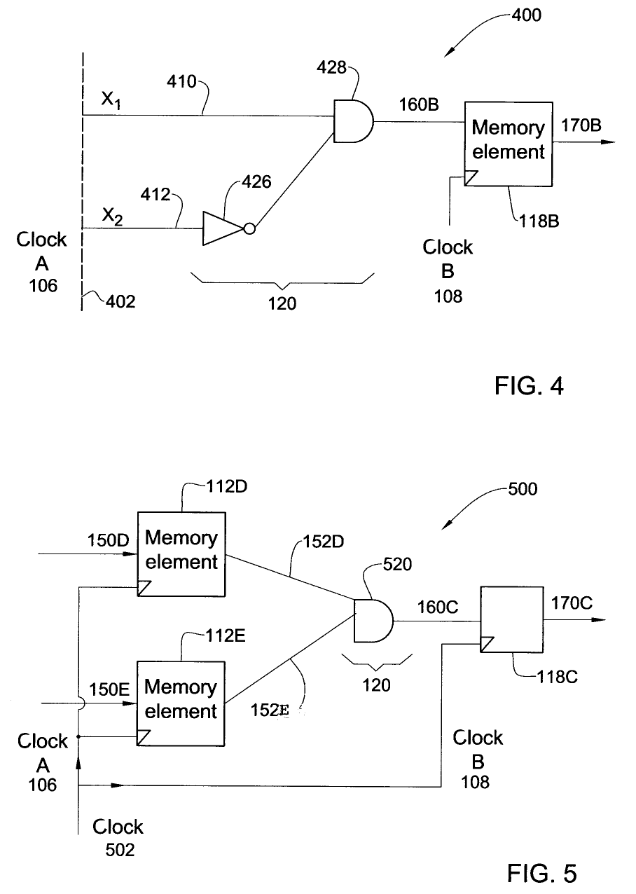

Refer now to FIG. 4 which illustrates a simplified logic circuit 400 with clock A 106 and clock B 108. In this example it is again assumed that clock A 106 and clock B 108 are synchronous and that clock B 108 operates at a higher frequency than clock A 106 (where N is the ratio of the frequencies of clock B 108 to clock A 106). In this example, the logic design and implementation of memory elements 112 driven by clock A 106 is unknown (i.e. to the left side of broken line 402). However there is a design contract requirement that data x₁ 410 be stable before Y₁% of clock A 106 and that data x₂ 412 be stable before Y₂% of clock A 106, where Y₁% and Y₂% may be the same or different. In FIG. 4, x₂ 412 feeds into a NOT gate 426, and the output of NOT gate 426 and x₁ 410 feed into an AND gate 428. The output of AND gate 428 (input 160) feeds into memory element 118B. In this example, once the triggering edge of clock A 106 has triggered the unknown memory elements 112, because of the propagation delay through logic 120, other unknown logic elements, (and/or wires), it is uncertain on which triggering edge of clock B 108 (beginning with the next triggering edge after the triggering edge of clock A 106 which triggered the unknown elements 112) output 170 will reach a valid logic state.

The reader will understand that in the example illustrated in FIG. 4, it would be difficult to apply the related art method of forcing logic circuit 400 to operate at the higher clock frequency of clock B 108 if Y₁% and/or Y₂% is greater than 1/N %, assuming as before that the frequency of clock B 108 is N times the frequency of clock A 106. The reader will also understand that in this example it would be difficult as per the related art to run an SDF driven simulation because the design is partially unknown.

Here and below, the term clock domain refers to a part of a design driven by a clock with the same frequency and phase. Therefore domains which have variable frequency and/or phase relationship are considered in this description to be different clock domains. Circuit 300 and 400 discussed above are illustrative of examples of paths which cross from a first clock domain to a second clock domain, where the first clock domain is driven by a synchronous clock with a smaller frequency than the synchronous clock driving the second clock domain.

One embodiment of the method and system of the invention can be used to verify paths crossing from a first clock domain to a second clock domain, where the first clock domain is driven by a synchronous clock with a smaller frequency than the synchronous clock driving the second clock domain. These paths are termed for ease of description “synchronous clock domain low to high frequency crossing paths” and the method and system of verifying such paths will be described further below.

However one embodiment of the method and system of the invention may be used to simulate paths which do not necessarily cross between clock domains and/or are not necessarily synchronous clock domain low to high frequency crossing paths. Refer to FIG. 5 which shows a simplified logic circuit 500 where synchronous clocks A 106 and B 108 are assumed to have identical frequency (in this case both are identical to clock 502). In logic circuit 500 memory elements 112D and 112E are driven by clock A 106 and the outputs 152D and 152E of memory elements 112D and 112E respectively are fed into logic 120 (here an AND gate 520). The output of AND gate 520 is fed into memory element 118C (as input 160C). Circuit 500 includes the assumption, for example specified by the designer of circuit 500, that output 170C of memory element 1118C should only be looked at after M cycles, because only then the validity of output 170C will be certain. In this example, once the triggering edge of clock A 106 has triggered the memory elements 112D and E, because of the propagation delay through logic 120 (and/or wires) it is uncertain on which triggering edge of clock B 108 (beginning with the next triggering edge after the triggering edge of clock A 106 which caused the change in output 152D and/or 152E) output 170C will reach a valid logic state. Specifically in this example, the designer has incorporated the assumption, whose reason may or may not be apparent to a viewer of circuit 500, that output 170C may reach a valid logic state (once the triggering edge of clock A 106 has triggered the memory elements 112D and E) after a path delay ranging from 0 cycles of clock B 108 (i.e. valid state on the next rising clock edge) to M−1 cycles of clock B 108 (i.e. valid state reached M rising edges later).

The reader will understand that it might be difficult as per the related art method to force logic circuit 500 to completely operate at the higher clock frequency of clock 502 because the assumption might be there to prevent operation at the higher frequency.

In circuits 100, 300, 400 and 500 discussed above there is assumed to be a synchronous relationship between clocks driving source memory elements (112, 112A, 112B, 112C, unknown, 112D, and/or 112E) and destination memory elements (118, 118A, 118B and/or 118C). However, the reader will understand that a designer of a path of a logic circuit can specify after how many cycles of a clock (here and below “M”) driving a memory element on the path, the output of the memory element will be considered valid, regardless of the frequency and phase relationship between clocks on the path. This freedom which allows a designer to specify M based on any suitable criteria may be considered an advantage of an embodiment of the invention in some cases.

In one embodiment, M is a natural number (i.e. an integer equal to greater than 1). Typically although not necessarily, the default is that M equals 1, i.e. the output of the memory element is valid in the single clock cycle of the clock (i.e. on the next rising edge), and therefore typically although not necessarily the designer will only explicitly specify M, if M is greater than 1. The reason for the designer specifying a particular M as being greater than 1 can be for any reason.

For synchronous clock domain low to high frequency crossing paths where the ratio of higher to lower frequencies is N, in many cases, the designer of the circuit will specify that M equals N, or there will be an automatic assumption that M equals N. In other cases, the designer of the circuit will specify that 1<M≦N. However, there is no required relationship between M and N in accordance with the present invention. Note also that there are no limitations in accordance with the present invention on the value of N.

For example, assume that in circuit 400, Y₁%=40%, i.e. input X₁ 410 must be stable until 40% of clock A 106 and that Y₂%=66%, i.e. input X₂ 412 must be stable until 66% of clock A 106 cycles. Now assume that clock A 106 operates at 50 MHz (20 ns per cycle) and clock B 108 at 200 MHz (5 ns per cycle). Therefore N=4. Out of the four possible stability subsets {0, 1, . . . , N−1}, X₁ 410 has two {0,1} as it can stabilize within the first or second cycle (40%*20 ns=8 ns which is <10 ns=2 clock B cycles). X₂ has three {0,1,2} subsets as X₂ 412 can stabilize within the first, second or third cycle (66%*20 ns=13.33 ns which is <15 ns=3 clock B cycles).

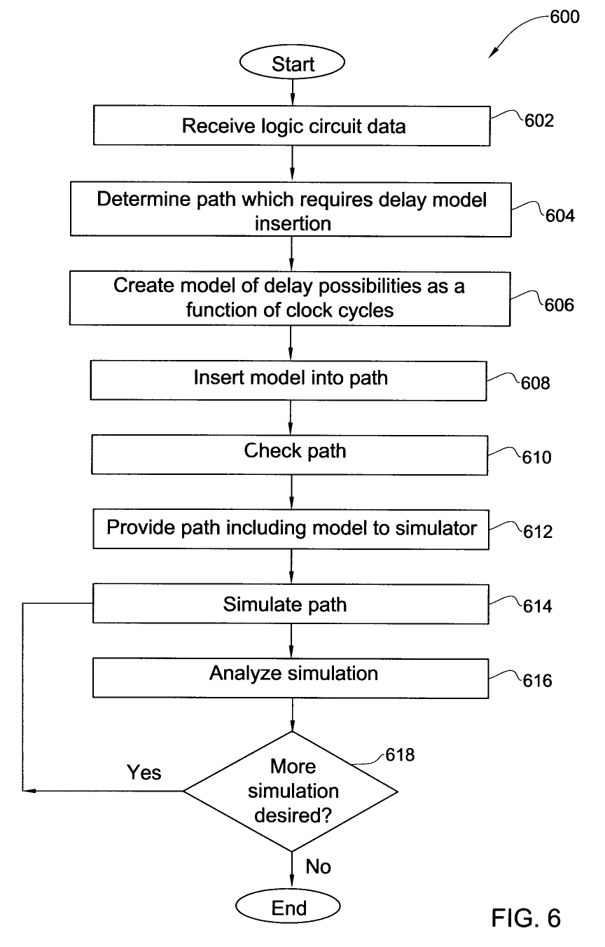

FIG. 6 is a flowchart of a method 600 for verifying logic circuits, according to an embodiment of the present invention. In one embodiment, functionality and timing of logic circuits are verified through simulation, with delays expressed as a function of clock cycles. The invention is not bound by the stages and/or the order of the stages shown in FIG. 6 and in other embodiments, less stages, more stages and/or different stages may be used in method 600. In other embodiments the order of the stages may differ, for example with one or more stages executed simultaneously.

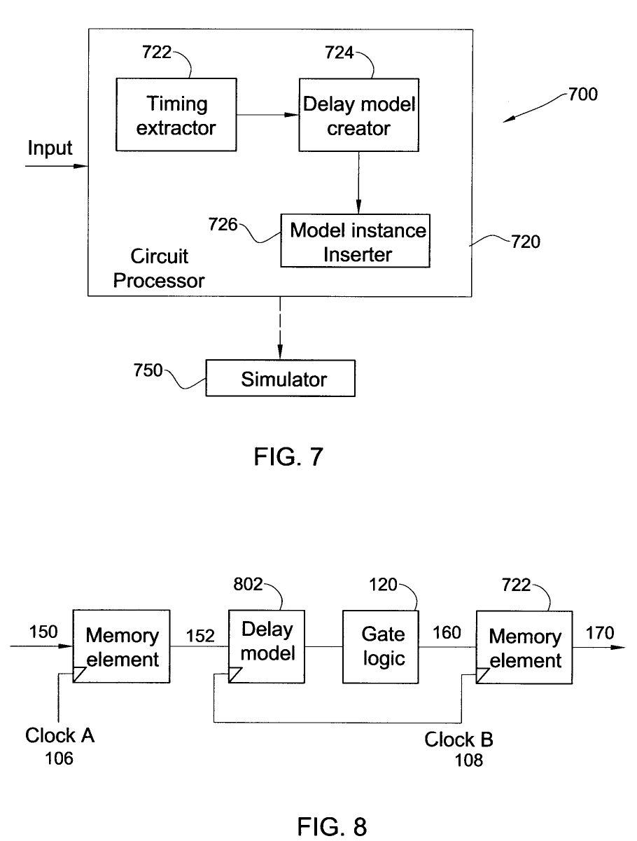

Method 600 will be explained in conjunction with a system 700 illustrated in FIG. 7 for executing method 600. System 700 includes a logic circuit processor 720 and a simulator 750. Circuit processor 720 and simulator 750 may be located in the same location or in different locations. Circuit processor 720 and simulator 750 are shown attached by a broken line which represents the transfer of the output from circuit processor 720 to simulator 750 either automatically, manually or semi-automatically through any suitable means. For example, in one embodiment the output of circuit processor 720 may be transferred through a suitable connection directly to simulator 750. As another example, in another embodiment, the output of circuit processor 720 may be viewed, checked, and/or processed further by a user/machine prior to being input into simulator 750.

Circuit processor 720 can be made up of any combination of software, hardware and/or firmware that performs the functions as defined and explained herein. In FIG. 7, circuit processor 720 is shown as comprising a timing extractor module 722, a delay model creator 724, and a delay model instance inserter 726. Each of modules 722, 724, and 726 may be made up of any combination of software, hardware and/or firmware that performs the functions as defined and explained herein. Depending on the embodiment of the invention, the functionality of circuit processor 720 may be provided by fewer, more, and/or different modules than those shown in circuit processor 720.

Simulator 750 may be any appropriate simulator, for example a cycle based or event driven simulator. Cycle based and event driven simulators are known in the art. In some cases it may be considered advantageous that the delays modeled by an embodiment of the invention can be simulated using cycle based simulators because not all types of delays can be simulated on cycle based simulators.

Examples of commercially available simulators which can be used as simulator 750 include inter-alia: 1. VCS available from Synopsys, Inc. headquartered in Mountain View, Calif.; 2. NC-Verilog or NC-sim available from Cadence Design Systems, headquartered in San Jose, Calif.; and 3. ModelSim available from Mentor Graphics headquartered in Wilsonville, Oreg. The Mesa simulator by International Business Machines Corporation IBM, headquartered in Armonk, N.Y. is a well known cycle based simulator although not currently externally sold. Some examples of simulators which are currently available and can be used inter-alia as simulator 750 are presented in www.deepchip.com/items/dac01-13.html, details of which are hereby incorporated by reference herein.

In stage 602, data on the logic circuit is received by circuit processor 720, for example by timing extractor 722. The received data allows circuit processor 720 to determine the paths on the logic circuit where delay models that are a function of clock cycles (herein below cycle delay model) should be instantiated.

In one embodiment, circuit processor 720 receives in stage 602 as part of the data on the logic circuit a functional description of the logic circuit path and/or timing information. Examples of functional description include inter-alia Register Transfer Level RTL code and/or schematics. An example of timing information includes inter-alia timing assertions and/or manually inputted timing information.

The RTL code can be written for example in Verilog, in Very High Speed Integrated Circuits Hardware Description Language VHDL, or in any other suitable language. Some of the currently available language hardware descriptive standards which can be used inter-alia for writing the RTL code are listed in www.eda.org, details of which are hereby incorporated by reference herein. The usage of RTL code for describing logic circuits is well known in the art and will therefore not be further discussed.

Timing assertions are in many cases developed for static timing analysis STA which is performed on a logic circuit. Static timing analysis analyses the performance of a logic circuit under the specified timing assertions. Examples of static timing analysis products which are commercially available from vendors include inter-alia “PrimeTime” from Synopsis, “Ambit” from Cadence and “Velocity” from Mentor Graphics. Typically although not necessarily, Register Transfer Level RTL code and timing assertions are input into the static timing analysis tool and the static analysis tool outputs log files which can be viewed by either a human or using the same vendor tools.

For example, Synopsys allows a timing assertion to be written which modifies the default single cycle timing relationship of a path to a multicycle M timing relationship using the set_multicycle_path command whose syntax and arguments are reproduced here: (Note that the default relationship can also be represented as a zero cycle path delay which is modified in the timing assertion to an M−1 cycles path delay. These two representations of 1->M or 0->M−1 are both used in the description here, as appropriate).

SYNTAX

```
int set_multicycle_path
    path_multiplier
        [-rise | -fall] [-setup | -hold]
        [-start | -end] [-from from_list]
        [-to to_list]
        [-through through_list]
        [-reset_path]
  int path_multiplier
  list from_list
  list to_list
  list through_list
```

### Arguments

path_multiplier

Specifies the number of cycles that the data path must have for setup or hold relative to the startpoint or endpoint clock before data is required at the endpoint. If you use -setup, this value is applied to setup path calculations. If you use -hold, this value is applied to hold path calculations. If you don't specify -setup or -hold, path_multiplier is used for setup, and 0 is used for hold. Note that changing the multiplier for setup affects the hold check as well.

-rise Indicates that rising path delays are affected by path_multiplier. The default is that both rising and falling delays are affected. Rise refers to a rising value at the path endpoint.

-fall Indicates that falling path delays are affected by path_multiplier. The default is that both rising and falling delays are affected. Fall refers to a falling value at the path endpoint.

-setup Indicates that path_multiplier is used for setup calculations.

-hold Indicates that path_multiplier is used for hold calculations.

-start|-end Indicates whether the multicycle information is relative to the period of the start clock or the end clock. These options are only needed for multifrequency designs; otherwise start and end are equivalent. The start clock is the clock source related to the register or primary input at the path startpoint. The end clock is the clock source related to the register or primary output at the path endpoint. The default is to move the setup check relative to the end clock, and the hold relative to the start clock. A setup multiplier of 2 with -end moves the relation forward one cycle of the end clock. A setup multiplier of 2 with -start moves the relation backward one cycle of the start clock. A hold multiplier of 1 with -start moves the relation forward one cycle of the start clock. A hold multiplier of 1 with -end moves the relation backward one cycle of the end clock.

-reset_path Indicates to remove existing point-to-point exception information on the specified paths. If used with -to only, all paths leading to the specified endpoints are reset. If used with -from only, all paths leading from the specified startpoints are reset. If used with -from and -to, only paths between those points are reset. Only information of the same rise/fall setup/hold type is reset. This is equivalent to using the reset_path command with similar arguments before the set_multicycle_path is issued.

-from from_list

A list of names of clocks, ports, pins, or cells to use to find path startpoints. If you specify a clock, all registers and primary inputs related to that clock are used as path startpoints. If you specify a

cell, one path startpoint on that cell is affected.

-to_list

A list of names of clocks, ports, pins or cells to use to find path endpoints. If you specify a clock, all registers and primary outputs related to that clock are used as path endpoints. If you specify cell, one path endpoint on that cell is affected.

-through through_list

A list of path throughpoints (port, pin, or leaf cell names) of the current design. The multicycle values apply only to paths that pass through one of the points in the through_list. If more than one object is included, the objects must be enclosed either in quotes or in ‘{ }’ braces. If you specify the -through option multiple times, the multicycle values apply to paths that pass through a member of each through_list in the order the lists were given. In other words, the path must first pass through a member of the first through_list, then through a member of the second list, and so on for every through list specified. If the -through option is used in combination with the -from or -to options, the multicycle values apply only if the -from or -to conditions are satisifed and the -through conditions are satisfied.

Using the syntax described above, output 170 in logic circuit 100 (FIG. 1) may be designated as valid after M cycles rather than after the default single cycle using a timing assertion such as the one written here:

set_multicycle_path (M−1)- setup -end- from {memory element 112}-to {memory element 118}

As another example, one “set_multicycle_path” statement may be used to designate all paths between memory elements driven by one clock and memory elements driven by a second clock as multicycle paths. For example for circuit 300, the following statement may specify that the paths between memory element 112A and memory element 118A, between memory element 112B and memory element 118A, and between memory element 112B and memory element 118A are multicycle M paths.

set_multicycle_path (M−1)- setup -end- from {points in RTL}-to {points in RTL}

In stage 604, circuit processor 720, for example timing extractor 722, determines the paths which should have a cycle delay model insertion. The determination can be made through any process.

For example, assume that circuit processor 720 received timing assertions in stage 602 for a logic circuit (either with or without functional description such as RTL code). The timing assertions may have been developed for STA analysis or may have been developed independently, for example specifically for use in simulation of the functionality and timing of the logic circuit in accordance with an embodiment of the invention. In stage 604, circuit processor 720 may search for all “set_multicycle_path” statements or the equivalent (for example which use the syntax of other STA products) in the timing assertions, and determine that for all paths with set-multicycle_path statements (or the equivalent), cycle delay model insertion is desirable. It is assumed for the sake of simplicity below that the set_multicycle path assertion or the equivalent is used for M greater than 1 but in some cases if timing assertions are also used for M=1. circuit processor 720 may discard all assertions with M=1 prior to proceeding with the rest of method 600.

As an example, assume that the timing assertions included the timing assertion for logic circuit 100 listed above as “set_multicycle_path (M−1)- setup-end-from {memory element 112}-to {memory element 118}”, circuit processor 720 will determine that the path between memory element 112 and memory element 118 should have a cycle delay model. As another example, assume the timing assertions included the timing assertion for logic circuit 300 listed above as set_multicycle_path (M−1)- setup-end- from {points in RTL}-to {points in RTL} then circuit processor 720 will determine that the paths between memory element 112A and memory element 118A, between memory element 112B and memory element 118A, and between memory element 112C and memory element 118A should have cycle delay models.

The timing assertions and/or other timing information may be inputted automatically into circuit processor 720 or may be manually inputted into circuit processor 720.

In another embodiment, assume that separate timing assertions/timing information are not received and only RTL code and/or or any other functional description of the logic circuit (for example circuit schematics, etc) is received in stage 602. In this embodiment, circuit processor 720 may in stage 604 read the RTL code or the other description of the logic circuit in order to determine where there are synchronous clock domain low to high frequency crossing paths. Circuit processor 720 will then designate any found synchronous clock domain low to high frequency crossing paths as paths where cycle delay model insertion is desirable. Continuing with the example, circuit processor 720 may read the RTL code and develop timing assertions for those found paths.

To further illustrate this other embodiment, assume circuit processor 720 receives RTL code and/or other functional description of circuit 300. Circuit processor 720 can recognize clock divider 310 and therefore determine that the paths between memory element 112A and memory element 118A, between memory element 112B and memory element 118A, and between memory element 112C and memory element 118A should have cycle delay models.

In another embodiment, circuit processor 720 uses a combination of RTL code/other functional circuit description and separate timing assertions/timing information to determine the paths where a cycle delay model insertion is desirable. In yet another embodiment, circuit processor 720 receives other data in stage 602 on the logic circuit which allows circuit processor 720 in stage 604 to determine where cycle delay model insertion is desirable.

As the reader will understand, in an embodiment where RTL code or any other functional description of the logic circuit (for example schematics, etc) is received without additional timing information in any format (for example in the format of timing assertions), circuit processor 720 depends on what is described/illustrated explicitly in the circuit and does not benefit from additional timing information. For example, circuit processor 720 when receiving circuit 500 without receiving any additional timing assumptions/information, will typically although not necessarily overlook the necessity of a cycle delay model on the path between memory element 112D or 112E and memory element 118 because memory elements 112D, 112E and 118 are driven by the same clock 502. As another example, when receiving circuits 300 where it is evident that there are synchronous clock domain low to high frequency crossing paths due to the presence of clock divider 310, circuit processor 720 will typically although not necessarily develop a cycle delay model identical to or based on N (the clock ratio), whereas timing assertions may have instead led to a cycle delay model based on M clock cycles, where M is not necessarily identical to or based on N. However, in some embodiments it may be considered sufficient for the purposes of the simulation to only model cycle delays which are described/illustrated explicitly in the circuit (for example for paths that are explicitly shown as synchronous clock domain low to high frequency crossing paths), or it may be known that no additional timing information is required for accurate simulation, and in these cases the receipt of RTL code or any other functional description of the logic circuit without additional timing information may be considered sufficient. The reader will understand that in some cases modeling cycle delays based on what is described/illustrated explicitly in the circuit without regard to timing assertions may result in unnecessary and costly simulations of certain scenarios which STA analysis had assured can not occur.

In stage 606 a delay model is developed by circuit processor 720, for example by delay model creator 724, for each path where it was determined in stage 604 that it would be optimal to have cycle delay model insertion. The cycle delay model specifies a path delay which can equal one or more integer multiples of the cycle of a clock driving a memory element on the path. In some cases it may be considered an advantage of an embodiment of the invention that the delay of the path is constrained to equal one or more integer multiples of clock cycles and that therefore the number of possible delays is limited to a finite discrete number of possibilities, which may be simulated and/or analyzed for extent of coverage. For ease of explanation, it is assumed below that delay models can be developed and instantiated which when simulated allows a selection from among one or more delay possibilities for a path. However, in other embodiments, separate delay models can be developed, instantiated and simulated for each delay possibility of a path, and similar methods and systems to those described here can be used, mutatis mutandis.

In some embodiments, the delay model is written in RTL code, for example in Verilog or VHDL, or as part of the description of the logic circuit.

For example, assume that in stage 602, the timing assertion for the path from memory element 112 to memory element 118 discussed above as “set_multicycle_path (M−1)- setup -end -from {memory element 112}-to {memory element 118” was received. Circuit processor 720 can in one of these embodiments in stage 606 develop a cycle delay model which when run by simulator 750, models a delay for this path as follows:

delay ε{(0×clockBcycles) . . . ((M−1)×clockBcycles)}

This cycle delay model models a path delay which may range from 0 to M−1 integer multiples of the cycles of clock B 108 (driving memory element 118).

In another of these embodiments, the delay model may model a path delay which includes a subset of the set of all possible delays, where the range of all possible delays is from 0 to M−1 integer multiples of clock B 108 cycles. For example the subset can include all odd integer multiples between 0 to M−1, all even integer multiples between 0 to M−1, the first few integer multiples between 0 to M−1, the last few integer multiples between 0 to M−1 or any other subset.

As another example, assume another embodiment where the RTL code for circuit 300 is received (without any additional timing information). Assume from the RTL code it can be determined in stage 604 as discussed above that the paths between memory element 112A and memory element 118A, between memory element 112B and memory element 118A, and between memory element 112C and memory element 118A are synchronous clock domain low to high frequency crossing paths. It is assumed also that from clock divider 310 the ratio of frequencies of synchronous clock B 108 to clock A 106 can be determined as being N. In this example, in stage 606 circuit processor 720 in stage 606 may develop a model which when run by simulator 750 models a delay as follows:

delay ε{(0×clockBcycles) . . . ((M−1)×clockBcycles)}

or circuit processor 720 may develop a model which when run by the simulator models a delay which is an element in a subset of this set.

Depending on the embodiment of this example, M may be set to N, to a number greater than 1 but less than or equal to N, to the closest integer greater than N (for example if N is a fraction), or to any integer greater than 1 based on suitable criteria for deriving M from N. In another embodiment of this example, there is no limitation on M and although it is more likely that M will be derived based on N, it is not necessary.

It should be evident to the reader that one cycle delay model may be developed in stage 606 which is valid for more than one path. For example, assuming that the timing assertion discussed above “set_multicycle_path (M−1)- setup -end- from {points in RTL}-to {points in RTL} ” is received for circuit 300. In this case, a delay model can be created which is valid for each of the paths memory element 112A and memory element 118, between memory element 112B and memory element 118, and between memory element 112B and memory element 118. Similarly, if RTL or any other functional description of the logic circuit is received, one cycle delay model may be developed for all synchronous clock domain low to high frequency crossing paths with the same high and low frequencies.

In one embodiment the cycle delay model is written in any code which simulator 750 can understand, for example Verilog, VHDL, C, etc. The invention is not bound by the format and content of the cycle delay model instance. However for ease of understanding of the reader, one simplified example of pseudo code for the cycle delay model is written here:

```
multi_cycle_delay_model (int configuration, int delay_choice)
{
    const Max_M (parameter set when instantiating the module);
    input fast_clock;
    input predelay_in;
    output delayed_out;
    if (configuration== RANDOM)
        delay_choice = rand( ) modulo Max_M
    else(configuration== FASTEST)
        delay_choice = 0
    else(configuration== SLOWEST)
        delay_choice = Max_M−1;
    delayed_out = predelay_in after delay_choice fast_clock cycles;
    module_coverage_vector [delay_choice] = TRUE;
    When end_of_test print module_coverage_vector;
}
```

In the above code, the number of cycles of delay can be specified as random, i.e. any path delay between 0 and M−1 cycles of a clock (here termed fast clock and in logic circuits 100, 300, 400 and 500 equivalent to clock B 108) may be simulated, as fastest, i.e. a zero cycle delay is simulated, or as slowest, i.e. an M−1 cycle delay is simulated. When running the above code, simulator 750 would output which multiple(s) of the cycle (ranging from 0 to M−1) were simulated (in this case simulator 750 would print the module_coverage_vector).

In stage 608, the cycle delay model developed in stage 606 is instantiated by circuit processor 720, for example by delay model instance inserter 726. Instantiation stage 608 includes circuit processor 720 inserting the developed cycle delay model into any paths where the desirability of a cycle delay model was determined in stage 604.

There may be more than one appropriate place to insert the model into the path. It should be evident to the reader that in some cases the exact placement of the model on the path may impact on the simulation whereas in other cases the exact placement may not make a difference. For example, assume as in FIG. 3 that the path between source memory element 112A and destination memory element 118A passes through NOT gate 322 and AND gate 328. If a cycle delay model is inserted between memory element 112A and NOT gate 322 or between NOT gate 322 and AND gate 328, there will be no practical different. However, there will be a practical difference between inserting a cycle delay model between memory element 112A and NOT gate 322 (or between NOT gate 322 and AND gate 328), or instead inserting a cycle delay model between AND gate 328 and memory element 118A. In the latter case, the same cycle delay model would function for each of the paths between memory element 112A, 112B, 112C and memory element 118A, therefore constraining simulator 750 in the same run to provide the same delay on each of these paths. Therefore, depending on the desirability of this constraint, the latter case may be chosen or not.

In one embodiment, in stage 608 cycle delay models are inserted so that the delay for each path is separately modeled (i.e. the delay for each path is distinguishable from the delay on other paths). For example for circuits 100, 300, 400, and 500 incorporating the delay model at the beginning of each path, for example as close as possible to the source memory element on each path and/or as close as possible to the beginning of the known design for each path allows for separate modeling of delays delay for each path. FIGS. 8, 9, 10 and 11 illustrate this embodiment for circuits 100, 300, 400 and 500 respectively.

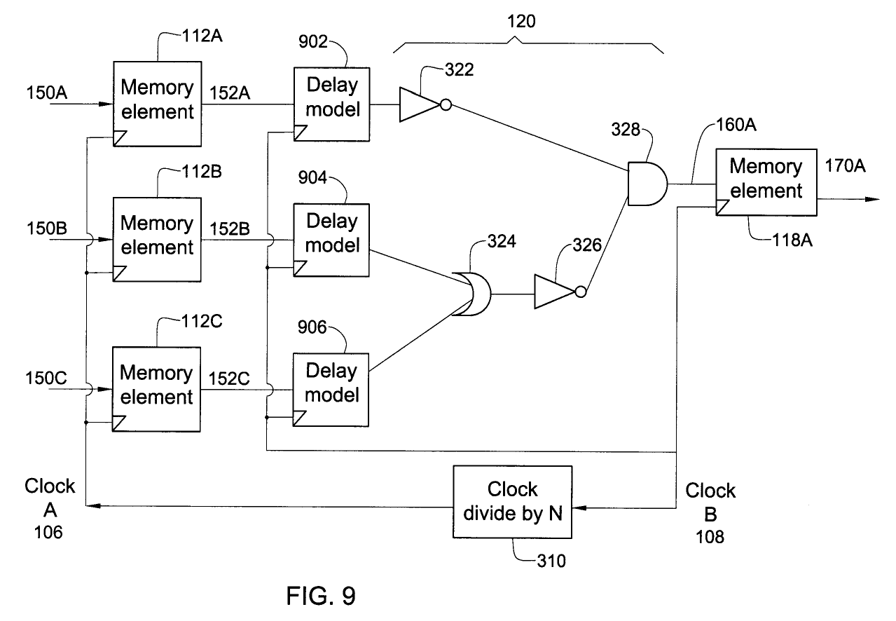

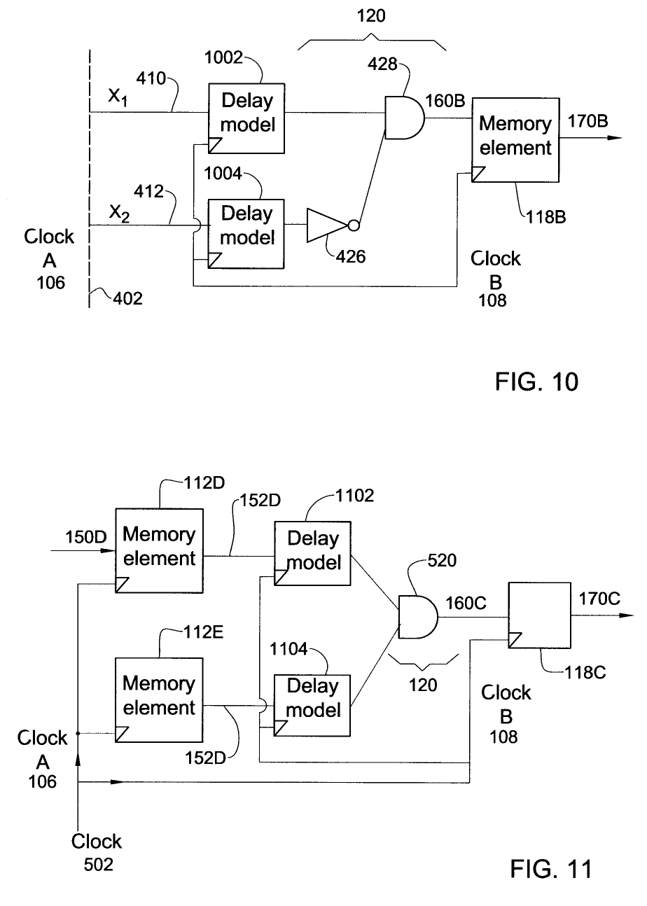

In FIG. 8, delay model 802 is placed at the output of memory element 1112. In FIG. 9, delay model 902 is placed at the output of memory element 112A, delay model 904 is placed at the output of memory element 112B and delay model 906 is placed at the output of memory element 112C. In FIG. 10, delay model 1002 is placed at the entry of x₁ 410 to the right side of broken line 402, i.e. to the known design and implementation and delay model 1004 is placed at the entry of x₂ 412 to the right side of broken line 402. In FIG. 11, delay model 1102 is placed at the output of memory element 112D and delay model 1104 is placed at the output of memory element 112E.

In other embodiments, some or all of delay models 802, 902, 904, 906, 1002, 1004, 1102 and 1104 may be placed at different points in logic circuit 100, 300, 400 and 500.

In an embodiment where no RTL code/other functional description was received in stage 602, stage 608 includes the creation of the path, for example by describing the path in RTL code/other functional description, and the incorporation of the delay model, for example written in RTL code, with the RTL code/other functional description for the path. In an embodiment where RTL code or another functional description of the path was received in stage 602, stage 608 includes the incorporation of the delay model, for example written in RTL code, with the RTL code or the other functional description for the path.

In one embodiment, the delay model is instantiated in stage 608 like any other RTL module. For example assume the delay model of FIG. 8 when created in stage 606 was called MaxMis4 (i.e. M=4), the following commands can instantiate a delay model named MaxMis4_p87 based on MaxMis4:

| multi_cycle_delay_model_MaxMis4 MaxMis4_987 | |
|---|---|
| (configuration= configuration; | |
| delay_choice= delay_choice) ( | |
| .fast_clock | ( Clock B ), |
| .predelay_in | ( signal_152), |
| .delayed_out | ( signal_160 ) ); |

In the above example a model of type multi_cycle_delay model with M=4 is instantiated and named MaxMis4_{—}987 in stage 608 using the above code. The configuration per test argument is passed on as is from a higher hierarchy (e.g. so all models for example will work together). Two inputs and output wires/signals are also connected.

Optionally in stage 608, the cycle delay model when inserted into the path is flagged as being for verification purposes so as to distinguish the cycle delay model from the functional elements of the path.

In some embodiments, circuit processor 720, for example model inserter 726, may optionally check in stage 610 that only one cycle delay model has been inserted per path. For example, circuit processor 720 may check that each path with the same source memory element/beginning point and the same destination memory element/ending point has only one delay model inserted. If more than one delay model has been inserted on the same path, the additional delay model(s) may be removed based on any criteria. For example in one embodiment, the delay model closest to the source memory element/starting point may be retained and any other delay models may be removed.

In another embodiment, more than one delay model may be inserted in a single path but in stage 610 there will be an optional check that the cumulative delay represented by the one or more delay models in the specific path does not exceed the allowed delay of M−1 clock cycles. For ease of explanation, in the description here it is assumed that there is a maximum of one delay model per path, but in embodiments where there can be more than one delay model, similar methods and systems to those described here can be applied, mutatis mutandis.

In stage 612, circuit processor 720 outputs the paths including the cycle delay models, where as mentioned above, the output from circuit processor 720 may or may not be transferred directly to simulator 750. In some cases it may be considered an advantage of an embodiment of the invention that the output allows for timing delays to be simulated. In one embodiment, simulator 750 receives code which simulator 750 can run, so in this embodiment the output of circuit processor 720 or the output of circuit processor 720 after further processing outside of circuit processor 720 should be executable by simulator 750. For example, if the simulator can execute Verilog, VHDL, or C, the output of circuit processor 720 can be encoded in any of these formats. In another embodiment, simulator 750 is configured to perform preprocessing of the input to provide executable code so the form of the output of circuit processor 720 need not necessarily be executable by simulator 750 (without further processing).

In the next two examples, assume that simulator 750 can execute RTL code. In the first example in stage 612, assume that RTL code was received in stage 602 (with or without timing assertions). In this example, in one embodiment the output from circuit processor 720 may include RTL code which describes the logic circuit with the delay models inserted in appropriate paths. In a second example, assume that only timing assertions/timing information were received without RTL code in stage 602. In this example, in one embodiment output from circuit processor 720 in stage 612 may include RTL code which describes any paths with instantiated delay models within the logic circuit. Continuing with this embodiment of this example, the RTL code describing the rest of the logic circuit can be incorporated (outside the circuit processor 720) with the output from circuit processor 720 (for example prior to being transferred to simulator 750 or within simulator 750).

Although stage 612 and FIG. 7 describe an embodiment where circuit processor 720 and simulator 750 are separate, in another embodiment the functionality of circuit processor 720 and simulator 750 may be integrated together and therefore in this other embodiment stage 612 refers to the provision of the paths to the integrated simulation functionality.

In stage 614, the paths including the cycle delay models are simulated. As discussed above the cycle delay model adds a delay to a path which is an integer multiple (0≦multiple ≦M−1) of the clock cycle driving the ending memory element on the path. The integer multiple may be any integer between 0 and M−1 or may be constrained to a subset by the model. During simulation, zero or more of the integer multiples specified by the model are simulated for the path. The invention is not bound by the order or the scope of the path simulation. For example, the simulation can be done separately for each path with a delay model, for a plurality of paths with delay models simultaneously, or for all paths with delay models simultaneously. As another example, the simulation of the paths including delay models can be performed separately or as part of the simulation of the logic circuit to which the paths belong. As another example, assuming the delay model for a path included the full range of delays from 0 to M−1 times the clock cycle, each delay model can be simulated M times, i.e. once for each integer multiple between 0 and M−1, or the delay model can be simulated less than M times. As another example, assuming the delay model for a path included a subset of the possible delays, the delay model can be simulated for each element in the subset or for less than each element in the subset. As another example, assume a plurality of paths with M₁, M₂, M₃, M₄, M₅, M₆ . . . for the delay model for each path. In one embodiment, the simulation will cover M₁×M₂×M₃×M₄×M₅×M₆× . . . cases. In another embodiment, the simulation may cover M₁+M₂+M₃+M₄+M₅+M₆+ . . . cases. In another embodiment, the simulation may cover M₁+M₂×M₃×M₄+M₅+M₆+ In another embodiment the simulation can cover a number of cases which is a different function of M₁, M₂, M₃, M₄, M₅, M₆ . . .

In one embodiment, the integer multiple for each path is selected randomly each time the path is simulated during the first round of simulation of the logic circuit. In this embodiment, therefore one or more of the same integer multiple(s) may be simulated more than once for some path, while other integer multiples may not be simulated at all for those paths. The number of times a path is simulated during the first round of simulation depends on the embodiment and is not limited by the invention.

In some embodiments, during simulation certain integer multiples are necessarily simulated. For example, in one of these embodiments, at least the path delay equal to M−1× the clock cycle is simulated for each path (whereas the M for each path and the clock cycle is not necessarily the same). In another of these embodiments, at least the path delay equal to 0 cycles is also or instead simulated for each path (where the clock cycle is not necessarily the same).

As mentioned above, simulation of paths including cycle delay models in stage 614 can be performed by any appropriate simulator 750, for example a cycle and/or event simulator.

Stages 616 and 618 are optionally executed in some embodiments.

In stage 616, analysis of the simulation can occur. For example, in one embodiment simulator 750 outputs simulation analysis, for example coverage information. Coverage information can include for example what exactly was simulated. For example, if the delay model for a path allows for a delay ranging from 0 to M−1 integer multiples of the cycles of a given clock, simulator 750 can output which of the multiples was actually simulated along with the results of the simulation for each of the simulated multiples (if any). The results of the simulation can be any appropriate results. For example in one embodiment the results can be circuit passed/failed for each simulated multiple. As another example, if a logic circuit included more than one path, say 3 paths, with a delay as an integer multiple ranging from 0 to M₁−1×clock₁ cycles, 0 to M₂−1×clock₂ cycles and 0 to M₃−1×clock₃ cycles respectively, (where the M's and clock cycles may or may not be identical for the 3 paths), simulator 750 can output which multiple for each path was simulated at the same time (i.e. report coverage for one path in correlation with coverage for other paths). In one embodiment, the coverage information that is outputted is sufficient to allow a reviewer of the coverage information to determine whether additional simulation is desirable.

In other embodiments, simulator 750 does not output analysis information. For example in some of these embodiments, coverage can be tracked through pre or post processing. Continuing with the example, assume an embodiment where separate delay models are developed and instantiated for each delay possibility on a path. Continuing with the example, assuming M=3, the pre-processing can prepare three separate delay models for the path where the deterministic value of the path delay will be 0, 1, or 2 clock cycles respectively and the simulation will check that the path passes for each of these delay models. In this embodiment it may therefore not be necessary to collect and analyze coverage information.

In stage 618, it is determined whether additional simulation is desirable for a path because previous simulation of the path was not adequate. The determination of whether additional simulation is desirable can be based on any suitable criteria. For example in one embodiment additional simulation may be considered desirable if the previous round(s) of simulation did not cover each possible path delay as specified in the model at least once or at least a predefined number of times. As another example in one embodiment, additional simulation may be desirable if the previous round(s) did not cover all pertinent path delays at least once or at least a predefined number of times. As another example, in one embodiment, additional simulation may be desirable if the path was not simulated at all or a predefined number of times. As another example, additional simulation may be desirable because a particular combination of delays for the path and one or more other paths was not simulated at least once or at least a predefined number of times.

If additional simulation is desirable, stage 614 is repeated. In the additional round of simulation, the simulation may be similar to the previous round of simulation. In other embodiments, the additional round of simulation may be more focused. For example, in one of these embodiments not all paths which were simulated in the previous round(s) may be simulated in the additional round, for example if coverage of those paths were considered sufficient in the previous round(s). As another example, the reviewer may specify which path delays which were not simulated adequately (either at all or in combination with certain path delays for other paths) should be simulated in this round. Continuing with this example, the reviewer can specify that a certain path delay should be simulated (at least once or at least a predefined number of times), optionally specifying particular delays on other paths with which that certain path delay should be simulated in combination.

In one embodiment stages 614 through 618 are simulated as many times as desired, until no more simulation is desired (stage 618), and method 600 ends.

In one embodiment of the invention, the cycle delay model is the only type of delay on the path of a logic circuit which is simulated in stage 614 and the exact timing for each gate and wires is not simulated (i.e. SDF simulation is not performed). In this embodiment, in some cases it may be considered advantageous that the typically slower SDF simulation is eliminated. In other embodiments, SDF simulation is performed during verification of the path of the logic circuit, for example with some rounds of simulation using cycle based delay models and other rounds of simulation using SDF delays.

In the description above it was assumed that M equals Mₛₑₜᵤₚ and that M_{hold} equals one, where Mₛₑₜᵤₚ represent the number of cycles of the clock during which an input to a memory element (for example input 160 in FIG. 1) should be stable with new value and M_{hold} represent the number of cycles the input to the memory element has to maintain the previous value before changing. However in other embodiments, M_{hold} may be greater than one (but typically less than or equal to M). In one of these embodiments, it may be beneficial to implement a delay model which sets the path delay to be between (Mhold−1) to (M−1) instead of setting the path delay to be between 0 to (M−1). In embodiments where the designer specifies both M and Mhold, the path delay model could be built using similar methods and systems to those described above, mutatis mutandis. For example, the integer multiple can be constrained to range between (Mhold−1) to (M−1) instead of between 0 to (M−1). As another example the delay model can be split into two delay models where one delay model adds a constant path delay of Mhold cycles and the other adds a variable path delay of Mₛₑₜᵤₚ−Mhold.

While the invention has been shown and described with respect to particular embodiments, it is not thus limited. Numerous modifications, changes and improvements within the scope of the invention will now occur to the reader.

What is claimed is:

1. A method of verifying a path in a logic circuit, comprising:
determining that a validity of an output logic level of a memory element on a path is uncertain for M clock cycles of a clock driving said memory element;
creating a delay model configured to model at least one of M possible integer multiples of clock cycles for said clock, said possible integer multiples ranging from 0 to M−1; and
instantiating said delay model in said path so that if said path is simulated, a path delay equaling an integer multiple of clock cycles for said clock is simulated for said path.

2. The method of claim 1, further comprising:
simulating said path at least one time.

3. The method of claim 2, wherein said simulating is performed a plurality of times, and wherein, a simulated path delay during one of said plurality of times differs from other simulated path delays.

4. The method of claim 2, further comprising:
analyzing said simulating.

5. The method of claim 4, wherein said analyzing includes:
reporting which integer multiple or multiples of said clock cycles had been simulated for said path and analyzing said reporting.

6. The method of claim 5, wherein said reporting on said simulated integer multiple or multiples is reported in correlation with path delays simulated for other paths.

7. The method of claim 4, further comprising:
if said analyzing leads to a decision to simulate said path some more, simulating for said path a path delay which has not been simulated adequately.

8. The method of claim 1, further comprising:
receiving information on said path which includes timing information that specifies validity after M cycles instead of default single cycle validity;
wherein said determining is based on said received timing information for said path.

9. The method of claim 8, wherein said timing information is a timing assertion in a format suitable for static timing analysis STA.

10. The method of claim 1, further comprising:
receiving a functional description of said path;
wherein said determining is based on recognizing from said received functional description that said path is a path which crosses from a clock domain driven by a lower frequency clock to a clock domain driven by said clock, and that said clock is synchronized with said lower frequency clock but has a higher frequency than said lower frequency clock.

11. The method of claim 10, further comprising:
setting M to equal a ratio of said higher frequency to said lower frequency as determined by a clock divider circuit between said clock and said lower frequency clock.

12. The method of claim 1, wherein said instantiating of said delay model is performed so that said path delay for said path is distinguishable from a path delay for any other path.

13. The method of claim 1, further comprising:
verifying that said path includes a maximum cumulative path delay of M−1 clock cycles.

14. The method of claim 1, wherein said path includes another clock on said path, and said clock and said another clock are synchronous.

15. The method of claim 14, wherein said another clock has a lower frequency than said clock, and wherein M is less than or equal to a ratio of the frequency of said clock to the frequency of said another clock.

16. A method of verifying a path in a logic circuit, comprising:
determining that a validity of an output logic level of a memory element on a path is uncertain for M clock cycles of a clock driving said memory element, wherein any other clocks on said path are synchronized with said clock;
creating a delay model configured to model at least one of M possible integer multiples of clock cycles for said clock, said possible integer multiples ranging from 0 to M−1;
instantiating said delay model in said path; and
simulating said path, wherein a path delay equaling an integer multiple of clock cycles for said clock is simulated for said path.

17. A system for verifying a path in a logic circuit comprising:
means for determining that a validity of an output logic level of a memory element on a path is uncertain for M clock cycles of a clock driving said memory element;
means for creating a delay model configured to model at least one of M possible integer multiples of clock cycles for said clock, said possible integer multiples ranging from 0 to M−1; and
means for instantiating said delay model in said path so that if said path is simulated, a path delay equaling an integer multiple of clock cycles for said clock is simulated for said path.

18. The system of claim 17 further comprising:
means for simulating said path at least one time.

19. The system of claim 18, wherein said means for simulating is cycle based.

20. The system of claim 18, further comprising:
means for reporting which integer multiple or multiples of said clock cycles had been simulated for said path; and
means for analyzing what said means for reporting has reported prior to deciding whether to simulate said path some more.
